(19) United States
(12) Patent Application Publication
(10) Pub. No.: US 2012/0185424 A1
(43) Pub. Date: Jul. 19, 2012

(54) FlexSCAPE: Data Driven Hypothesis Testing and Generation System

(75) Inventors: Akhileswar Ganesh Vaidyanathan, Landenberg, PA (US); Eric N. Jean, Denver, CO (US); Mani Thomas, Hillsborough, NJ (US); David Louis Hample, Newark, DE (US); Michael Thomas McGowan, Newark, DE (US); Jijun Wang, Hockessin, DE (US); Eli T. Faulkner, Wilmington, DE (US); Jay Dee Askren, Bear, DE (US); Albert Josef Boehmler, West Grove, PA (US); Durban A. Frazer, San Francisco, CA (US)

(73) Assignee: QUANTUM LEAP RESEARCH, INC., Claymont, DE (US)

(21) Appl. No.: 12/862,657

(22) Filed: Aug. 24, 2010

Related U.S. Application Data
(63) Continuation-in-part of application No. 12/829,241, filed on Jul. 1, 2010.
(60) Provisional application No. 61/236,382, filed on Aug. 24, 2009.
(60) Provisional application No. 61/222,458, filed on Jul. 1, 2009.

(51) Int. Cl. G06N 5/02

(52) U.S. Cl. 706/52

(57) ABSTRACT

The present invention relates to a method for generating hypotheses automatically from graphical models built directly from data. The method of the present invention links three key scientific concepts to enable hypothesis generation from data driven hypothesis-models: including the use of information theory based measures to identify informative feature subsets within the data; the automatic generation of graphical models from the informative data subsets identified from step one; and the application of optimization methods to graphical models to enable hypothesis generation. The integration of these three concepts can enable scalable approaches to hypothesis generation from large, complex data environments. The use of graphical models as the model representation can allow prior knowledge to be effectively integrated into the modeling environment.

### CROSS REFERENCE TO RELATED APPLICATIONS

The present application claims priority from U.S. Provisional Application Ser. No. 61/236,382, filed on 24 Aug. 2009 and is a Continuation-in-Part of U.S. Conventional application Ser. No. 12/829,241 filed 1 Jul. 2010, which claims priority from U.S. Provisional Application Ser. No. 61/222,458, filed on 1 Jul. 2009.

### STATEMENT REGARDING FEDERALLY SPONSORED RESEARCH OR DEVELOPMENT

Portions of the present invention were developed with funding from the Office of Naval Research under contracts N00014-09-C-0033, N0014-08-C-0036, and N00014-05-C-0541.

### BACKGROUND OF THE INVENTION

Hypothesis generation and testing has long been a cornerstone for the scientific method. The traditional scientific process has been to perform experiments to gather data. The data is then analyzed and human expertise is used to explain the data in the form of scientific principles that act both as an effective data compression mechanism as well as a means for generating new hypotheses that can be tested. More recently, with the rapid growth in data collection and the development of new data analysis methods, the question of whether the traditional scientific process can be facilitated through automation has become increasingly important.

The method of the present invention uses data to automatically build “hypothesis-models” which can be used to test and generate hypotheses. A hypothesis may be viewed as a “control strategy” aimed at achieving a desired result. For example, in a health care/life sciences context, a hypothesis can represent a preferred combination of treatments to mitigate the future impact of a disease. In a manufacturing context, a hypothesis can represent a set of process conditions that can optimize desired product properties. In a financial context, a hypothesis can represent a trading strategy to maximize profits. In the method of the present invention, a hypothesis thus represents a set of actions that can be taken in order to achieve a desired result with high probability. An important element of the present invention is to generate one or more hypotheses directly from data through the analysis of automatically generated hypothesis-models. In addition, the methods of the present invention can be extended to time varying data environments to enable both a forecasting capability as well as dynamic risk management strategies.

The method of the present invention links three key scientific concepts to enable hypothesis generation from data driven hypothesis-models:
1. Use of information theory based measures to identify informative feature subsets within the data.
2. Automatic generation of graphical models from the informative data subsets identified from step 1.
3. Application of optimization methods to graphical models to enable hypothesis generation.

The integration of these three concepts can enable scalable approaches to hypothesis generation from large, complex data environments. The use of graphical models as the model representation can allow prior knowledge to be effectively integrated into the modeling environment.

Furthermore, the method of the present invention extends the concepts outlined above to time varying data environments to enable both a forecasting capability as well as dynamic risk management strategies. In this instance, the graphical models encode temporal associations across the data, and the application of optimization methods on these dynamical graphical models results in prognostic hypotheses with associated uncertainties. Dynamic control strategies in a probabilistic data environment can be used in health care and life sciences to drive personal treatment strategies, in condition based maintenance to drive prognostic component maintenance strategies, and in financial services to drive optimal portfolio management and trading strategies.

### PRIOR ART

Bayesian networks are probabilistic graphical models that represent a set of random variables and their conditional independencies via a directed acyclic graph (DAG). The transparency of Bayesian networks enables the representation of hierarchical relations between variables through parent-child linkages (see for example, Pearl, Judea (2000). Causality: Models, Reasoning, and Inference. Cambridge University Press. ISBN 0-521-77362-8). There is an extensive literature relating to the learning of Bayesian networks directly from data (Heckerman, David (Mar. 1, 1995). “Tutorial on Learning with Bayesian Networks”. in Jordan, Michael Irwin. Learning in Graphical Models. Adaptive Computation and Machine Learning. Cambridge, Mass.: MIT Press. 1998. pp. 301-354. ISBN 0-262-60032-3; Neapolitan, R. E., Learning Bayesian Networks, Prentice Hall, Upper Saddle River, N.J., 2004). Structure learning methods such as the well known K2 algorithm assume a hierarchical ordering of variables to guide the learning (e.g. The well known K2 algorithm, Cooper, G. F. and Herskovits, E. (1992) A Bayesian method for the induction of probabilistic networks from data. Mach. Learn, 9, 309-347.) Faulkner (“K2GA: Heuristically Guided Evolution of Bayesian Network Structures from Data”, Faulkner, E., Proceedings of the IEEE Symposium of Computational Intelligence and Multi Criteria Decision Making, Honolulu Hi., Apr. 1-5, 2007) has described heuristic methods for finding optimal variable ordering to guide structure learning. However, as Bostwick et al have discussed, “the entire prior hypothesis space for even a moderately large relational database is so large that any Bayesian network attempting to capture it would be computationally intractable. (For example, some nodes would have tens or hundreds of thousands of states).” (CADRE: A System for Abductive Reasoning over Very Large Datasets; Daniel F. Bostwick, Daniel B. Hunter, and Nicholas J. Pioc www.aaai.org/Papers/Symposia/Fall/2006/FS-06-02/FS06-02-008.pdf).

Yuan et al discuss a general framework for generating multivariate explanations in Bayesian networks. However, they do not discuss the automatic generation of Bayesian networks from data to drive their explanation framework. (Yuan, C. and Lu, T. C. A General Framework for Generating Multivariate Explanations in Bayesian Networks Proceedings of the Twenty-Third AAAI Conference on Artificial Intelligence (2008) pp 1119-1124). Hypothesis generation associated with Bayesian networks has been primarily used in systems biology. Botstein et al discuss the use of a “A Bayesian framework for combining heterogeneous data sources for gene function prediction (in Saccharomyces cerevisiae)” where the role of data is primarily to provide evidence to Bayesian network models that have been constructed by domain experts rather than from the data (Troyankayi, O. G., Dolinski, K., Owne, A. B., Altman, R. B. and Botstein, D., A Bayesian framework for combining heterogeneous data sources for gene function prediction (in Saccharomyces cerevisiae) PNAS Jul. 8, 2003 vol. 100 no. 14 8348-8353). In the systems biology community, hypothesis generation from Bayesian networks has primarily been associated with the validation of linkages within a Bayesian network structure that has been postulated by domain experts (Weinreb G. E., Kapustina, M. T., Jacobson K., Elston T. C., In Silico Generation of Alternative Hypotheses Using Causal Mapping (CMAP), PloS ONE 4 (4): e5378. doi:10.1371/journal.pone.0005378, 2009; Rodin, A., Mosley, T. H., Clark, A. G., Sing, C. F. and Boerwinkle, E., Mining Genetic Epidemiology Data with Bayesian Networks Application to APOE Gene Variation and Plasma Lipid Levels, J. Comput. Biol.: 12 (1): 1-11, 2005; Pratt, D. R. et al, Causal Analysis in complex biological systems, U.S. Patent No. 2007,0225956, issued Sep. 27, 2007). In U.S. Pat. No. 7,512,497 (Periwal, V., Systems and methods for inferring biological networks, issued Mar. 31, 2009), optimization methods are used to infer cellular networks from a database of links. However, this patent does not teach how to generate the links database using information measures applied to raw data. In U.S. Pat. No. 6,941,287 (Vaidyanathan, A. G. et al, Distributed hierarchical evolutionary modeling and visualization of empirical data, issued Sep. 6, 2005) and in Vaidyanathan, G., InfoEvolve™: Moving from Data to Knowledge using Information Theory and Genetic Algorithms, Ann. NY Acad. Sci., 1020:227-238, 2004, Nishi entropy methods are used to identify informative features from data. However, Vaidyanathan et al do not teach the automatic generation of Bayesian networks from the data. In addition, Vaidyanathan et al do not teach the use of optimization methods applied to Bayesian networks to generate hypotheses.

In the present invention, a hypothesis is defined by a set of variable states that optimize a statistical measure associated with a desired outcome. The measure is computed using one or more Bayesian networks that have either been constructed directly from an informative data subset or that have been guided by an informative data subset. Further, the methods of the present invention alleviate the scalability difficulties by using information theory based feature reduction techniques to identify an informative subset of features using a mutual information measure. The reduced data set can be used by a structure learning algorithm such as the K2GA algorithm for efficient structure learning. One or more network structures can be learned from the data. The methods of the present invention further apply optimization methods on the informative Bayesian network structures to generate optimal hypotheses. The three key elements of the present invention: Information theory guided feature reduction, automated structure learning and automated hypothesis generation using optimization technologies provide the basis for scalable data driven hypothesis generation and testing.

The method of the present invention can also be extended to dynamical systems to provide a basis for dynamic risk management. In a dynamic environment, individual features can be extended into a list of (feature, time offset) feature pairs, where the time offset is measured against a reference time. The methods of the present invention can be used to analyze the extended dimensionality space covered by time stamped feature pairs to:
a. Reduce the dimensionality of the feature pair space using information theory based measures.
b. Sort the feature pairs in descending order so that the earlier time offsets occur earlier than the later time offsets.
c. Automatically generate at least one dynamic Bayesian network from the sorted data. Sorting the data as described will preserve the proper temporal sequencing between nodes within the network.
d. Apply optimization methods to at least one dynamic Bayesian network to generate a hypothesis.
e. Apply inference techniques on at least one dynamic Bayesian network to test a hypothesis.

The capability to generate a hypothesis from a data driven, dynamic Bayesian network can alleviate problems associated with classical time series analysis techniques such as ARIMA, recurrent neural networks and Monte Carlo Markov Chains which are difficult to employ in high dimensional data environments (Murphy. K. P. Dynamic Bayesian Networks: Representation, Inference and Learning, Ph.D dissertation, University of California Berkeley, 2002).

The information theory based measures to reduce the dimensionality of the feature pair space can be used to zoom in on the most informative time lags to drive forecasts. In addition, the probabilistic nature of Bayesian networks can be used to calculate the uncertainty of the forecast that can be used as a basis for dynamic risk management in several domains, including financial services, health care and life sciences and manufacturing.

### SUMMARY OF THE INVENTION

The method of the present invention (Flexscape™) uses data to automatically build “hypothesis-models” which can be used to test and generate hypotheses. The data that is used to build hypothesis-models can either be raw or derived data or data that is generated from the behaviors of other models or simulations. A key distinctive element of the present invention is to drive hypothesis testing and generation from hypothesis-models that are built from data rather than driving hypothesis testing and generation directly from the data itself. Many methods typically drive hypothesis testing and generation directly from the data. Driving hypothesis testing and generation directly from the data can result in potentially noisier hypotheses due to the increased noise in raw data versus the lower amount of noise in models that are built from the data.

An additional advantage of the method of the present invention lies in the fact that models built from data are typically much smaller in size than the data that they represent. This makes hypothesis testing and generation from models more computationally efficient, especially in large data environments. As the data volume continues to increase rapidly, the scalability of the method of the present invention therefore becomes increasingly valuable.

More generally, data driven hypothesis testing and generation is important in domains where there may not be a priori mathematical models of the underlying system that is being modeled. In many complex, adaptive systems, the relationship between system behavior and the underlying features representing the system can be highly non-linear and multi-dimensional. Modeling these systems with a priori mathematical models from which hypotheses can be tested and generated can lead to significant biases and resulting errors. For these types of applications, empirical hypothesis generation and testing is important, and forms the motivation for the present invention.

To test a hypothesis, the user provides data inputs to the hypothesis-models and Flexscape will produce probability distributions for model outputs. To generate a hypothesis, the user defines desired model output states, and Flexscape will produce states for data inputs that will maximize the probability of achieving the desired output states. The data that is used by Flexscape to test and generate hypotheses can come either from existing databases that contain raw or derived data, or “behavioral” databases that contain data that describe the behaviors of “primary” models or simulations run under different conditions. The hypotheses in the former case represent hypotheses that are based on hypothesis-models built directly from the data; the hypotheses in the latter case represent hypotheses that are based on hypothesis-models that are built from the behaviors of primary models or simulations under different conditions. In addition, the data used by Flexscape can also come from a streaming data environment, for example across mobile networks. The primary models or simulations can themselves be derived either from data or from a priori knowledge. Hypotheses based on primary models or simulations that are built from data can be more informative in cases where the underlying data has significant amounts of noise, as these models or simulations may be viewed as noise filters that increase the signal to noise of the data environment.

In addition, filters can be applied to the data coming from raw or derived databases or from behavioral databases prior to hypothesis generation in order to improve the signal to noise of the data environment. The filtered data can be used as the basis for both hypothesis testing and generation resulting in potentially more informative hypotheses.

The hypotheses that are generated by Flexscape can also be used in a feedback scheme to refine and focus the data gathering process. If a hypothesis is identified that indicates a particular control strategy is informative, more data can be gathered to further test and validate that strategy. This process can be repeated iteratively to progressively refine and adapt the hypotheses.

### BRIEF DESCRIPTION OF THE DRAWINGS

FIG. 1 illustrates the overall process flow of the present invention.

FIG. 2 illustrates the input data screen to the Flexscape platform.

FIG. 3 illustrates the information theory based feature identification within the Flexscape platform.

FIG. 4 illustrates a Bayesian Network implementing the present invention.

### DETAILED DESCRIPTION OF THE INVENTION

The Flexscape system has three core components: 1) Automatic hypothesis-model building from data; 2) Hypothesis testing using the hypothesis-models; and 3) Hypothesis generation using the hypothesis-models.

The automatic hypothesis-model building component can work with both complete and incomplete data sets where the incomplete data sets can have missing data fields. One or more models can be built directly from the data. Hypothesis testing generates output predictions from the hypothesis-models given a set of input conditions defined by input features being in specified states. For hypothesis generation, Flexscape uses optimization techniques to generate one or more hypotheses automatically from the hypothesis-models.

In preferred embodiments of the present invention, the three core components are further implemented as described below:

Automatic Hypothesis-Model building from data.

In a preferred embodiment of the present invention, the user can specify the variables in the data that represent “target” variables against which hypotheses are subsequently tested and generated. The user can also specify, either through automated methods or by using human judgment, variables that can be ignored from future consideration. The ability to ignore variables from future consideration becomes important when the number of variables is large. The remaining variables represent “control” variables whose states translate into the hypotheses against the target(s). In the method of the present invention, information theory based measures form the basis for automated feature selection.

In order to improve the computational efficiency of hypothesis-model building, it is often useful to decompose data sets into smaller data subsets. Data sets can be decomposed into one or more data subsets where each data subset contains either a subset of data records (“row subsets”) or a subset of features (“feature subsets”) or a subset of both data records and features (“row-feature subsets”). In a preferred embodiment of the present invention, data subsets can first be decomposed into row subsets. Measures based on mutual information can then be used to identify informative feature subsets within each row subset to generate a population of smaller row-feature subsets.

In another preferred embodiment of the present invention, optimization techniques can be used to guide the selection of the informative feature subsets consistent with user provided constraints. For example, the user might require that an individual feature appear in a predetermined number of feature subsets. The resulting row-feature subsets are used for subsequent hypothesis-model building. One or more hypothesis-models can be automatically generated from each row-feature subset.

In the method of the present invention, one or more hypotheses can be generated from individual hypothesis-models, thus providing a plurality of hypotheses that can subsequently be validated. This latter characteristic of the present invention is important in complex systems where some hypotheses may be infeasible to implement.

In a preferred embodiment of the present invention, transparent models such as Bayesian network models or decision tree models are used as the modeling paradigm for building hypothesis-models. Such modeling paradigms provide an explanatory capability that is hard to achieve with black box modeling paradigms such as neural networks. In addition, the use of Bayesian network models facilitates the estimation of missing data values during the hypothesis-model generation process. Furthermore, confidence measures of hypotheses generated from Bayesian models are most directly related to inherent epistemic uncertainty in the data. In other modeling paradigms such as neural networks, the inherent epistemic uncertainty is often confounded with model structure uncertainty resulting in potentially higher bias in the resulting hypotheses.

### Hypothesis Testing Using the Models

The population of one or more hypothesis-models generated from the data can be used to test hypotheses against the target variables. Data evidence is presented to a subset of the control variables and the states of the target variables are predicted by the hypothesis models.

In a preferred embodiment of the present invention, if data evidence is not presented to a specific control variable, the prior probability distribution for the states of the control variable is used to assign a state for the control variable.

In another preferred embodiment of the present invention, this process is repeated multiple times to generate a distribution of target variable predictions. The distribution of target variable predictions can then be analyzed to generate consensus predictions for the target variable(s).

### Hypothesis Generation Using the Hypothesis-Models

The population of one or more hypothesis-models generated from the data can further be used to generate hypotheses against the target variables. Searching techniques can be used to identify combinations of specific control variable states that maximize the probability of target variables being in desired states.

In a preferred embodiment of the present invention, optimization techniques are used to search the control variable state space efficiently in order to generate hypotheses. Further, in a preferred embodiment of the present invention, the Quantum Leap Adaptive Optimization Engine is used to search the control variable state space using multiple, diverse optimization methods to generate multiple hypotheses. (J. B. Elad et al, U.S. Pat. No. 5,195,172 issued Mar. 16, 1993, J. B. Elad et al, U.S. Pat. No. 5,428,712 issued Jun. 27, 1995).

The application of one or more optimization techniques to search the control variable state space permits the identification of a plurality of hypotheses that satisfy the user defined constraints. In the method of the present invention, statistical confidence measures associated with each hypothesis are automatically generated as outputs.

### Overall Process Flow

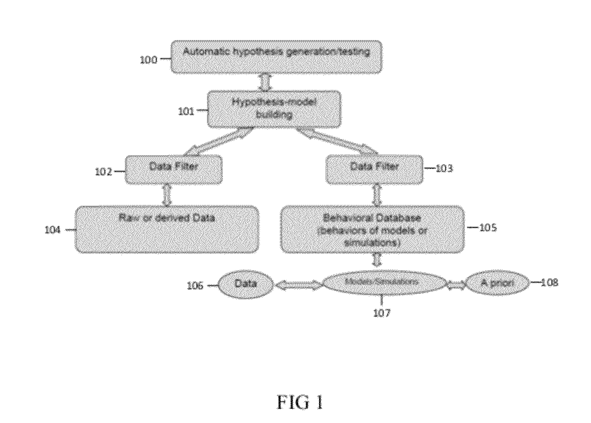

In FIG. 1, block 104 shows raw or derived data being fed into block 102 where data filtering can be performed using information measures to identify the most informative features. The enriched data set is then fed into block 101 where the hypothesis-models are built. The hypothesis models are then fed into block 100 where hypotheses are generated using optimization techniques and also tested.

In an alternative embodiment of the present invention, either data from block 106 or a priori knowledge from block 108 is fed into block 107 to drive a modeling and simulation engine. Data generated from the simulations is used to populate a behavioral database in block 105. The data from the behavioral database is fed into block 103 where data filtering can be performed using information measures to identify the most informative features. The enriched data set is then fed into block 101 where the hypothesis-models are built. The hypothesis models are then fed into block 100 where hypotheses are generated using optimization techniques and also tested.

Examples of applications of the present invention.
A) Modeling Future Behaviors from Models and Simulations of Complex, Adaptive Systems

Generate a behavioral data base that encodes future behaviors of models and simulations of complex, adaptive systems such as infectious and chronic disease spread, manufacturing processes, financial systems etc. in the presence of changing input conditions. Automatically build a population of behavioral hypothesis-models from the behavioral data that anticipate future behaviors Generate and test prognostic hypotheses against the anticipated future behaviors using the behavioral hypothesis-models.

B) Generating and Testing Hypotheses Directly from Data Bases

Build hypothesis-models directly from existing data bases such as those in health care and life sciences, manufacturing or financial domains. Generate and test hypotheses using the hypothesis-models against a range of target variables consistent with potentially changing constraints.

### C) Prognostic Hypothesis Generation in Health Care and Life Sciences

The capabilities summarized in bullets (A) and (B) directly above are particularly valuable in the domain of health care and life sciences. From (A), if a biological system (or sub system) can be modeled as a complex, adaptive system, future behaviors of the system can be simulated under different treatment options. Examples of such systems could include specific types of cancers such as colon cancer, breast cancer etc, cardiovascular systems or neurological systems. The method of the present invention can analyze a behavioral database that encodes the behavior of such systems under different treatment options to determine the most promising treatment options as early as possible. This type of analysis can potentially improve health outcomes through early and targeted treatment of disease.

In addition, the method of the present invention can be used to analyze existing health care databases to generate hypotheses around treatment options. Personal patient information can be used along with treatment and symptom information to test and generate hypotheses around the best courses of treatment against one or more diseases at the level of an individual. In this application of the method of the present invention, the ability to handle missing data effectively is important, since missing data fields are common in the electronic histories of patients.

### Extensions to Dynamic Risk Management

In a complex, dynamic, data driven environment where uncertainty is the norm, it is essential that principled data analysis techniques be used to both assess and control risk. In this application, we define risk in terms of the probabilistic uncertainty in achieving a desired objective. In particular, we focus on the problem of dynamic risk management where there is a temporal component that must be taken into account. There are many classical approaches to temporal forecasting, including the use of Hidden Markov models, recurrent neural networks, and linear approaches such as ARIMA (“Dynamic Bayesian Networks: Representation, Inference and Learning”, Ph.D dissertation, Kevin Patrick Murphy, University of California, Berkeley, 2002). These methods often require the user to know in advance the time horizons that can influence a future outcome. Moreover, they cannot always effectively model long term dependencies and do not generally permit the introduction of human domain knowledge. Further, many classical approaches do not deal efficiently or effectively with multivariate inputs and/or outputs.

An effective approach to dynamic risk management that alleviates the problems outlined above is to use a hybrid strategy where human domain expertise can be used to guide an empirical data driven approach to discover the optimal (variable,time) pairs that can influence a future outcome. The method of the present invention describes a multi-stage approach towards implementing such a hybrid strategy:

a) Information theory based discovery of informative time lags in a dynamical data environment:

Each input variable x, is expanded into a variable pair (xᵢ,tⱼ) for multiple preceding times tⱼ that cover an envelope lag period that can be estimated from domain knowledge. The resulting data table can potentially be high dimensional as each input variable is now replicated at multiple time points. The methods of the present invention describe the reduction of the dimensionality of large temporal data sets using information theory. A high dimensional temporal space can be searched efficiently using genetic algorithms or other optimization technologies that use mutual information metrics as the fitness functions to identify key variable pairs that influence the desired target pair (y,t_{future horizon}) at a future time horizon.

The proposed approach can be used in a multi-scale fashion at successive levels of temporal resolution to identify optimal time windows. For example, an initial data table can be created with the temporal unit being weeks; once a set of specific informative week-based lags have been identified, a second data table can be created by resolving the selected week(s) at higher temporal resolution.

An important advantage of the methods of the present invention to temporal pattern discovery lies in the ability to identify combinations of temporal patterns that, working together, can influence a target variable at a future time. In complex environments, it is often the case that multiple variables in specific states at different times are informative to influencing a future outcome. The methods of the present invention include the extension of mutual information calculations to multi-dimensional variable sets in a scalable fashion. The critical variable pairs are thus identified in the context of inter-variable interactions in a dynamic environment. A smaller subset of variable pairs that participate most frequently in informative inter-variable interactions can be used to reduce the dimensionality of the data environment in order to build more compact, informative Bayesian network (BN) models as described below.

b) Sorting the selected most informative variable pairs in descending order according to the time lags (from maximum time lags to minimum time lags) to drive a Bayesian network structure learning algorithm such as the well known K2 algorithm.

There are many well known Bayesian network structure learning algorithms described in the literature (see for example “Learning Bayesian Networks”, Richard E. Neapolitan, Prentice Hall Series in Artificial Intelligence, 2003 and references contained therein). Many of the well established methods such as the K2 algorithm assume a given node ordering of the variables that can drive the structure development from root nodes to leaf nodes. The methods of the current invention describe sorting the informative variable pairs identified in step 1 in descending order of time lags to ensure that the leaf nodes within the BN follow earlier nodes from a time sequencing standpoint to preserve causality. This is a key inventive step in the automatic generation of dynamic Bayesian networks.

One or more BN's can be automatically generated from the data depending on the number of variable pair feature sets that are selected from step 1. The ensemble of Bayesian networks can be scored for quality and a subset of Bayesian networks can be selected as models that can be used to provide risk estimates using probabilistic optimization methods that are outlined below.

c) Applying probabilistic optimization (otherwise known as inductive reasoning) on each of the BN's described in step b to generate a sequence of actions that can be taken at preceding times across different control variables to optimally influence the target pair at a future time horizon. This optimization can be performed with multiple temporal/process constraints. Applying optimization techniques on dynamic Bayesian networks represents an important inventive step in this application as a means for enabling dynamic risk control.

d). The dynamic Bayesian networks generated in step b can also be used to forecast risk by performing a forward inference to estimate the likelihood of the (target,time) pair at a future time.

The key inventive step in this application includes the combination of three technology components for enabling scalable dynamic risk assessment and control:
1. Identification of informative (variable, time) pairs against a future (target,time) outcome using an information theory based approach.
2. Automatic generation of dynamic Bayesian networks from the informative pairs described in step 1.
3. Application of optimization methods on the dynamic Bayesian networks to optimally control risk.

The combination of the three technology components described above can enable a probabilistic assessment of unlikely but high impact events referred to as “black swan” events. Tracking the probability of these events over time can provide a basis for the timely implementation of strategies to mitigate risk, or of contingency plans to effectively manage the consequences of the black swan event. A good example of such a scenario is the breakdown in financial markets due to unanticipated events that may nevertheless have been implicitly identified due to data gathered in the period preceding the breakdown.

### Domain Examples for Methods of Present Invention:

### Health Care and Life Sciences

With the prevalence of electronic health records and other data tracking of the medical histories of patients, new opportunities for longitudinal data analysis that include a temporal component are emerging rapidly. The methods of the present invention can help identify critical linkages such as those between personal biological data, lifestyle, medications and subsequent tendency for a particular disease or health outcome of interest.

In recent times, there have been significant advancements in the collection and integration of disparate biological and health care data. This data can span multiple scales from genetic data to patient health outcomes of interest. The next frontier is to analyze these big, integrated data sets to generate predictions and strategies for treatment potentially at the level of each individual. The methods of the present invention address this type of analysis.

### Financial Modeling

Financial time series have been modeled using a variety of classical temporal forecasting approaches as described above. A key attribute of financial data is the low signal to noise ratio. Financial data is very noisy, and filtering out noise prior to generating strategies is critical. The methods of the present invention utilize information theory based approaches to identify informative variable pairs as a precursor to building dynamic Bayesian models. Generalizing information theory based dimensionality reduction techniques to temporal environments as a basis for building causally consistent Bayesian networks provides significant computational and noise reduction capabilities that the subsequent probabilistic optimization step can exploit to generate optimal trading decisions and portfolio risk management. More specifically, dynamic data driven probabilistic models can be used to identify trading opportunities with high probability of success and conversely conditions that may result in high probability of failure. Triaging the trading environment into these sub-environments can provide significant benefit as knowing when not to act is as important as knowing when to act, especially when using highly leveraged trading strategies.

### Condition Based Maintenance

In a cost constrained manufacturing environment, proactive generation of maintenance schedules to minimize the risk of subsequent component malfunction has become increasingly important. The ability to forecast failure modes in advance is complicated by the increasing complexity of machines. This can translate into high dimensional data environments with complex inter-variable interactions. The methods of the present invention can enable the automatic generation of prognostic models to predict the likelihood of component malfunction given current machine performance as measured by multiple sensors or other indicators. In addition, optimal maintenance strategies can be induced from the Bayesian networks using optimization methods. The ability to estimate the probability of a failure mode, rather than using a rigid decision rule, can enable a more intelligent asset maintenance strategy as the risk of failure can now be explicitly factored into the decision process.

### Example: Combinatorial Chemistry Application/Rational Drug Discovery:

As an example of the method of the present invention, we present an application from combinatorial chemistry where the objective is to identify combinations of chemical sub-structures that maximize the likelihood that a molecule has the desired biochemical activity against a specified target. Generating hypotheses around optimum sub structures can facilitate new approaches to rational drug discovery. In this example, we use a data set consisting of 7812 compounds where each compound is described by 960 binary structural descriptors. Only 56 compounds are active against the target, with the remaining 7756 compounds inactive. In the method of the present invention, mutual information measures were used to reduce the 960 binary structural descriptors into an initial list of the 100 most informative individual descriptors. Mutual information measures were then used to further reduce the 100 most informative features down to 12 features that participated most often in informative combinations against the target.

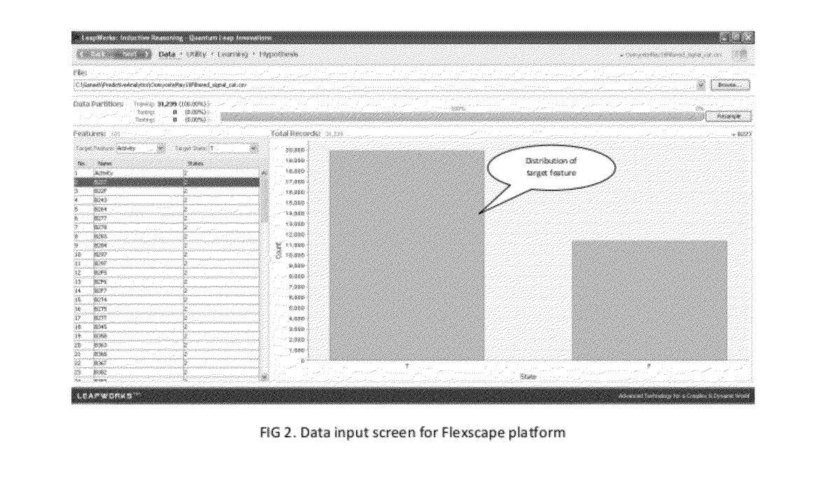

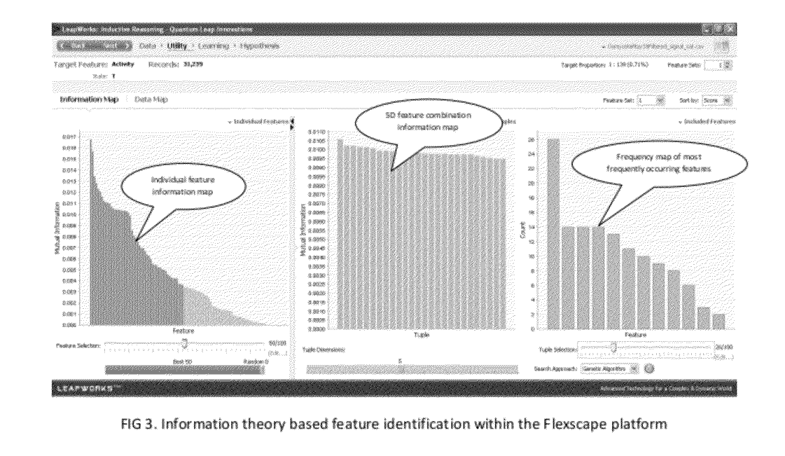

FIG. 2 shows the data input screen into the Flexscape platform where a tabular list of all the variables along with a histogram of their state distributions is displayed. FIG. 3 shows a series of histograms that rank both individual variables and combinations of variables from an information theory based perspective. The frequency map plot on the extreme right of FIG. 3 indicates the 12 features that participated most often in informative combinations against the target.

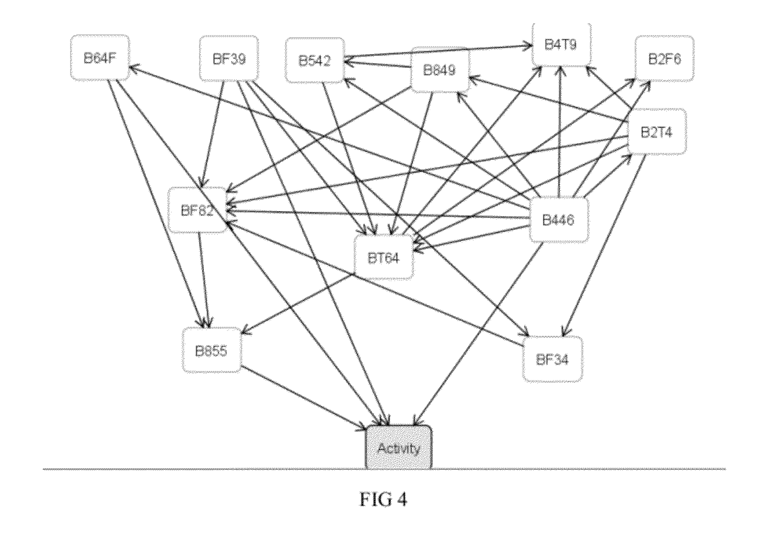

A Bayesian network was built automatically from the reduced data set (FIG. 4). Optimization techniques were then applied to the Bayesian network to maximize the likelihood that the Activity feature is in the active state. The results are summarized in Table 1 below. The four decision features in this example are the parents of the Activity feature, representing the Markov blanket, as shown in FIG. 4. The remaining descriptors are denoted as “observable” features. The hypothesis generated by the method of the present invention specifies that all the decision structural features should be present to maximize the probability that the compound is active. Further, probabilities for the remaining features to be present are provided. The overall probability that this hypothesis results in a biochemically active compound is 0.5039, which is significantly enhanced over the 0.0072 baseline probability derived from the data statistics. In addition to generating an optimal hypothesis, the Bayesian network in FIG. 2 reveals extended associations across all the features that can provide critical system understanding to the medicinal chemist.

TABLE 1
Hypothesis generated from Bayesian network

| Descriptor | | | |
|---|---|---|---|
| Type | Descriptor | Prob(Absent) | Prob(Present) |
| Decision | B446 | 0 | 1 |
| | B64F | 0 | 1 |
| | B855 | 0 | 1 |
| | BF39 | 0 | 1 |
| Observable | B2F6 | 0.1102 | 0.8898 |
| | B2T4 | 0.025 | 0.975 |
| | B4T9 | 0.0463 | 0.9537 |
| | B542 | 0.0417 | 0.9583 |
| | B849 | 0.0105 | 0.9895 |
| | BF34 | 0.4921 | 0.5079 |
| | BF82 | 0.5967 | 0.4033 |
| | BT64 | 0.1232 | 0.8768 |

We claim:

1. In a computer system, having one or more processors or virtual machines, each processor comprising at least one core, one or more memory units, one or more input devices and one or more output devices, optionally a network, and optionally shared memory supporting communication among the processors, a method for automatically generating and testing a hypothesis from a data set comprising the steps of:
(a) selecting at least one informative combination of interacting features from a data set from the one or more memory units using a mutual information measure of the feature combination as the evaluation criterion;
(b) building at least one graphical model from at least one informative combination of interacting features;
(c) generating a hypothesis from at least one graphical model by optimizing a statistical measure associated with at least one state of at least one feature wherein the hypothesis is defined by at least one state associated with at least one feature from the data set; and
(d) testing at least one hypothesis generated from substep (c) from at least one graphical model.

2. The method of claim 1 wherein the mutual information measure in step (a) is at least one selected from the group consisting of:
mutual information, conditional mutual information, multi-variate mutual information, absolute mutual information and normalized mutual information.

3. The method of claim 1 wherein the graphical model in step (b) is at least one selected from the group consisting of:
any graphical model representing probabilistic relationships, a Bayesian network, a Naïve Bayesian network, a directed acyclic graph, a graphical Gaussian model, a Markov network, Partially Observable Markov Decision Process model, a Hidden Markov model, and a partially observable Markov decision process.

4. The method of claim 1 wherein the building at least one graphical model in step (b) can be performed by learning the model from the data.

5. The method of claim 1 wherein the building at least one graphical model in step (b) can be performed manually.

6. The method of claim 1 wherein the optimization method in step (c) is at least one selected from the group consisting of:
active set methods, ant colony optimization, arc-consistency enforcement, A-star, barrier functions, Boolean satisfiability, breadth-first search, Broyden-Fletcher-Goldfarb-Shannon algorithm, concave programming, cone programming, constraint ordering, constraint propagation, constraint sampling, differential evolution, direct search methods, evolutionary algorithms, exhaustive enumeration, expectation maximization, general conjugate-directional methods, generalized reduced gradient, generate and test, genetic algorithms, grid-wise enumeration, hardest-constraint-first, heuristic unidirectional minimization, heuristic uni-variate, integer programming, iterative repair algorithms, iterative-deepening-a-star, linear programming, mixed integer programming, model reduction, model partitioning, multivariate search, Nelder-Mead algorithm, node-consistency enforcement, particle swarm optimization, path-consistency enforcement, penalty functions, Polak-Ribiere algorithm, primal/dual linear programming, pseudo-Boltzmann search, pure random sampling, quadratic programming, quasi-Newton methods, relaxation techniques, semi-definite optimization, depth-first search, sequential linear programming, sequential quadratic programming, sequential uni-variate search, simple adaptive statistical search, simulated annealing, tabu search, trust region methods, uni-variate search, variable ordering, and zoomed enumeration.

7. The method of claim 1 wherein the statistical measure in step (c) is at least one selected from the group consisting of:
posterior probability, likelihood, and generalized Bayes factor.

8. The method of claim 1 wherein the hypothesis generation in step (c) can occur with at least one feature in a defined state.

9. The method of claim 1 wherein the testing of a hypothesis in step (d) can be performed using an inference technique on the graphical model.

10. The method of claim 1 wherein the graphical model in step (b) can be a dynamical graphical model that encodes a temporal component.

11. The method of claim 1 wherein the step of selecting at least one informative combination of features from the data set in step (a) for a temporal data set further comprises the step of:
expanding each feature at a reference time point into a list of (feature, time offset) feature pairs wherein each (feature, time offset) feature pair encodes a feature state at a particular time offset from the reference time point.

12. The method of claim 11 wherein the time offset can refer to a time earlier than the reference time point.

13. The method of claim 11 wherein the time offset can refer to a time later than the reference time point.

14. The method of claim 1 wherein the step of building a graphical model in step (b) for the case of a dynamical graphical model further comprises the steps of:
(a) Sorting the (feature, time offset) feature pairs such that the earlier time offsets occur before the later time offsets in the sorted list; and
(b) Building a graphical model that preserves the temporal order in the sorted list.

15. The method of claim 1 wherein the data set can be derived from a database environment.

16. The method of claim 1 wherein the data set can be derived from a streaming data environment.

17. The method of claim 1 wherein the data set can be derived from a simulation environment.

18. The method of claim 1 wherein the testing of a hypothesis in step (d) can be used to forecast future behavior of at least one financial market as a basis for developing a trading strategy.

19. The method of claim 1 wherein the step of generating a hypothesis in step (c) can be used to identify an optimal health treatment strategy for a patient.

20. The method of claim 1 wherein the step of generating a hypothesis in step (c) can be used to identify an optimal manufacturing process control strategy.
